(19) United States
(12) Patent Application Publication
(10) Pub. No.: US 2008/0247004 A1
(43) Pub. Date: Oct. 9, 2008

(54) SYSTEM AND METHOD FOR WORKFLOW CONTROL OF SCANNED DOCUMENT INPUT

(76) Inventor: Michael Yeung, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/695,958

(22) Filed: Apr. 3, 2007

(51) Int. Cl. H04N 1/04

(52) U.S. Cl. 358/486

(57) ABSTRACT

The subject application is directed to a workflow control system and method for scanned document input. Electronic document data is received from an associated scanning device. Document processing instruction data is then received associated with a plurality of document processing operations to be performed on the electronic document. The document processing instruction data is then appended to the electronic document as metadata. The electronic document data and appended metadata is then communicated to at least one document processing device for processing thereon. Upon receipt of the electronic document data, the at least one document processing device commences the plurality of document processing operations on the electronic document data in accordance with the appended metadata.

### BACKGROUND OF THE INVENTION

The subject application is directed to a system and method for workflow control of scanned document input. More particularly, the subject application is directed to a system and method for appending metadata to a scanned document, which metadata dictates a plurality of document processing operations.

Tangible documents are frequently scanned into electronic document form. Conversion of tangible document to electronic document form facilitates many other document processing operations. Such operations include archiving, optical character recognition, retransmission, copying, alteration, formatting, merging or other operations that are readily performed on electronic documents.

Given the myriad of options for electronic documents, it is often desirable to perform several operations. By way of example, a tangible letter may be received by a business. is Once scanned, the letter may be sent as an electronic document, such as by electronic mail attachment, to one or more recipients. The original may optionally be destroyed, relying on the electronic copying for archival purposes, and thus negating considerable accumulated storage requirements for hard copy documents.

The versatility of scanned document input will frequently merit completion of more than one function on a document. This will typically require a user to isolate an electronic document, and then work to perform each of a series of operations on such electronic document.

### SUMMARY OF THE INVENTION

In accordance with one embodiment of the subject application, there is provided a system and method for workflow control of scanned document input.

Further, in accordance with one embodiment of the subject application, there is provided a system and method for workflow control of a scanned document in order to perform a plurality of document processing operations on such a document.

Still further, in accordance with one embodiment of the subject application, there is provided a system and method for appending metadata to a scanned document, which metadata dictates a plurality of document processing operations.

Further, in accordance with one embodiment of the subject application, there is provided a workflow control system for scanned document input. The system includes means adapted for receiving electronic document data form an associated scanning device and means adapted for receiving document processing instruction data associated with a plurality of document processing operations to be performed on received electronic document data. The system also includes means adapted for appending metadata corresponding to document processing instruction data to electronic document data. The system further includes means adapted for communicating the electronic document data and appended metadata to at least one associated document processing device so as to commence the plurality of document processing operations on the electronic document data in accordance with the appended metadata.

In one embodiment of the subject application, the plurality of document processing operations are chosen from the set comprising: optical character recognition, page orientation, page alignment, digital certification, storage, transmission, and information extraction. Preferably, information extraction includes at least one of extraction of invoice number, sender information, destination information, and content information.

In another embodiment of the subject application, the system further comprises means adapted for receiving a notification signal representative of at least one of a completion and processing error associated with document processing operations specified by the metadata. Preferably, the system also includes means adapted for generating a message to an associated user in accordance with a received notification signal. More preferably, the message is comprised of an electronic mail message.

In yet another embodiment of the subject application, the at least one associated document processing device includes a multifunctional peripheral device.

Still further, in accordance with one embodiment of the subject application, there is provided a workflow control method for scanned document input in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the workflow control system for scanned document input according to one embodiment of the subject application;

FIG. 2 is a block diagram illustrating device hardware for use in the workflow control system for scanned document input according to one embodiment of the subject application;

FIG. 3 is a functional diagram illustrating the device for use in the workflow control system for scanned document input according to one embodiment of the subject application;

FIG. 4 is a block diagram illustrating controller hardware for use in the workflow control system for scanned document input according to one embodiment of the subject application;

FIG. 5 is a functional diagram illustrating the controller for use in the workflow control system for scanned document input according to one embodiment of the subject application;

FIG. 6 is a block diagram illustrating a server for use in the workflow control system for scanned document input according to one embodiment of the subject application;

FIG. 7 is a flowchart illustrating a workflow control method for scanned document input according to one embodiment of the subject application;

FIG. 8 is a flowchart illustrating a workflow control method for scanned document input according to one embodiment of the subject application; and

FIG. 9 is a flowchart illustrating a workflow control method for scanned document input according to one embodiment of the subject application.

### DETAILED DESCRIPTION OF THE PREFERRED EMBODIMENT

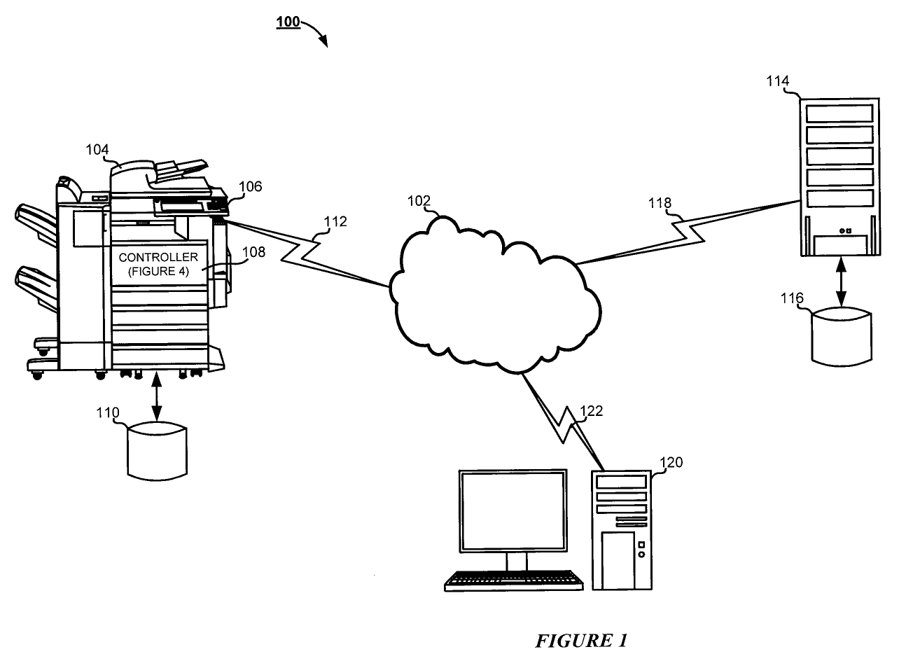

The subject application is directed to a system and method for workflow control of scanned document input. In particular, the subject application is directed to a system and method for workflow control of a scanned document in order to perform a plurality of document processing operations on such a document. More particularly, the subject application is directed to a system and method for appending metadata to a scanned document, which metadata dictates a plurality of document processing operations. It will become apparent to those skilled in the art that the system and method described herein are suitably adapted to a plurality of varying electronic fields employing workflow control of processing, including, for example and without limitation, communications, general computing, data processing, document processing, or the like. The preferred embodiment, as depicted in FIG. 1, illustrates a document processing field for example purposes only, and is not a limitation of the subject application solely to such a field.

Referring now to FIG. 1, there is shown an overall diagram of the workflow control system 100 for scanned document input in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

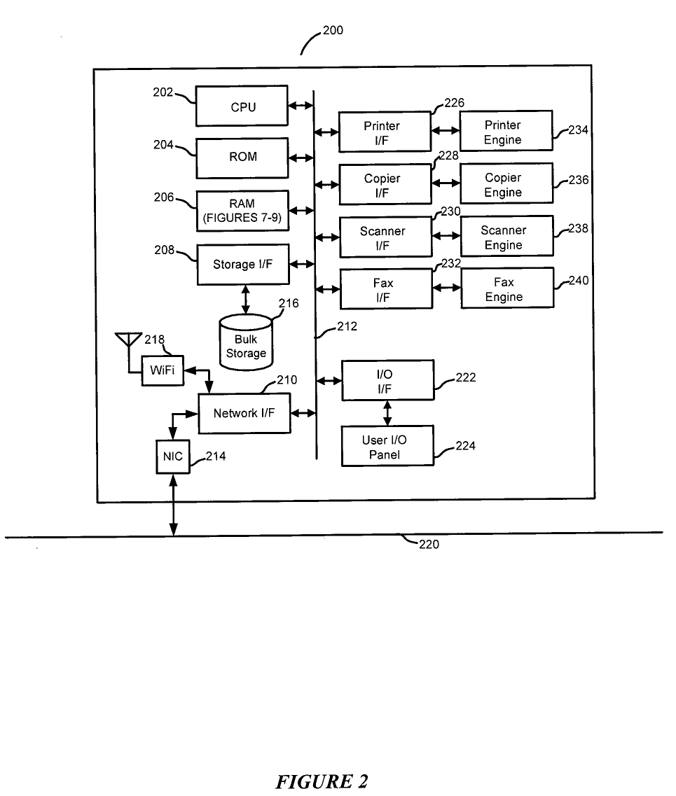

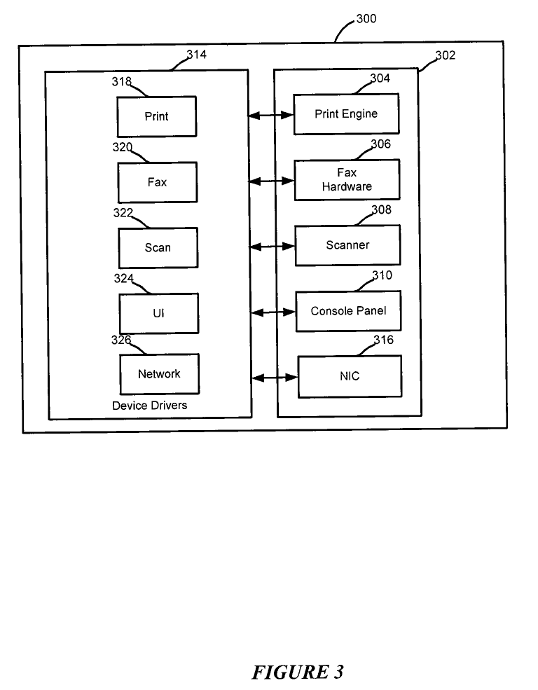

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

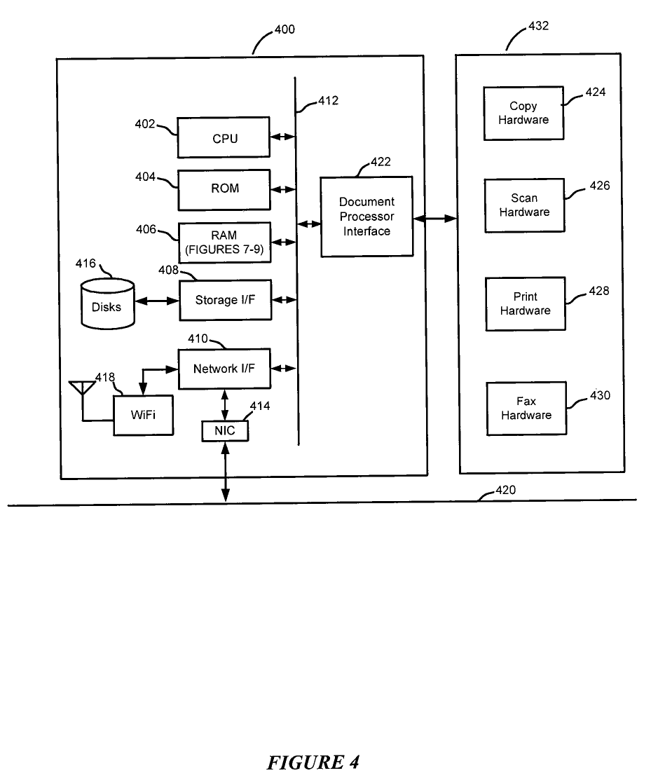

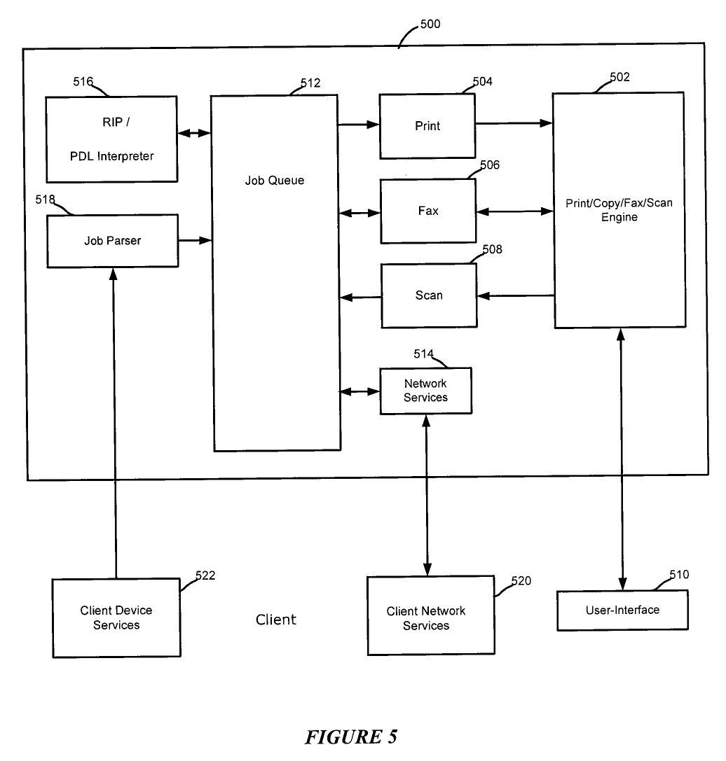

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the workflow control system and method for scanned document input of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data storage device 110 includes data representative of user account information, electronic documents, images, text, multimedia files, addresses, and the like.

The system 100 of FIG. 1 further includes a document management system server 114, functioning to facilitate the access, storage, and management of a plurality of devices and documents via the computer network 102 over the communications link 118. According to one embodiment of the subject application, the communications link 118 is capable of securely transmitting and receiving communications via the computer network 102. As will be understood by those skilled in the art, suitable communications links include, for example and without limitation, 802.11a, 802.11b, 802.11g, 802.11(x), Bluetooth, WiMax, infrared, optical, a proprietary communications network, the public switched telephone network, or any suitable wireless data transmission system, or wired communications known in the art.

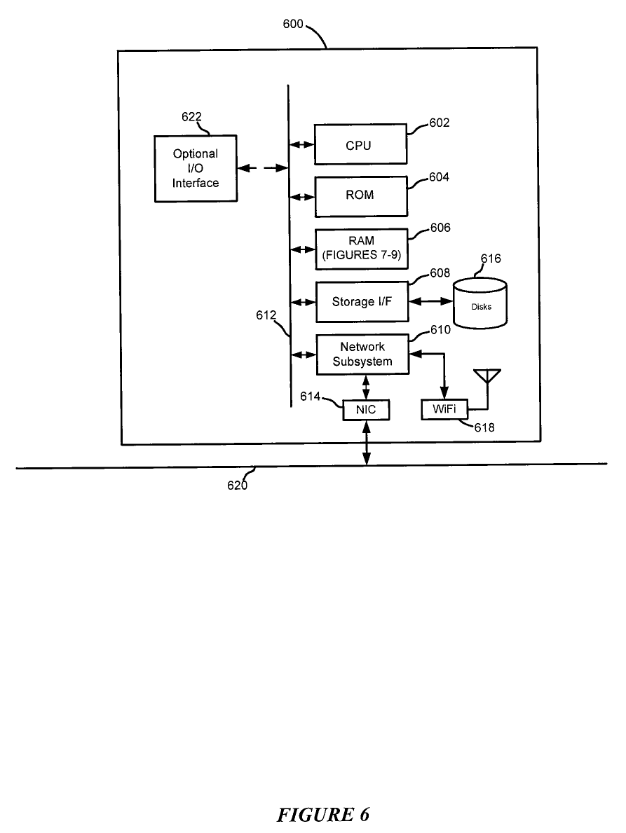

Preferably, the server 114 is suitably adapted to receive and process a variety of requests received via the computer network 102, including, for example and without limitation, document routing requests, document output requests, document storage requests, electronic mail communications, and the like. As will be appreciated by those skilled in the art, the server 114 is further capable of communicating document data via the computer network 102 to a plurality of devices, such as, for example and without limitation, a computer workstation, a smart phone, a portable data assistant, a document processing device, a facsimile machine, a printer, or the like. The functioning of the management server 114 will better be understood in conjunction with the block diagram illustrated in FIG. 6, explained in greater detail below.

Communicatively coupled to the server 114 is a data storage device 116. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. In the preferred embodiment, the data storage device 116 is suitably adapted to store document data, image data, electronic database data, applications, programs, or the like. It will be appreciated by those skilled in the art that while illustrated in FIG. 1 as being a separate component of the system 100, the data storage device 116 is capable of being implemented as internal storage component of the server 114, such as, for example and without limitation, an internal hard disk drive, or the like. In accordance with one embodiment of the subject application, the data storage device 106 includes data representative of a plurality of electronic documents, e.g., images, text, audio, video, multimedia, etc., user accounts, network device data, and the like. Preferably, the server 114 and the data storage device 116 function as a document management system, enabling the creation, storage, management, and processing of a plurality of electronic documents, accounts, and the like.

The system 100 illustrated in FIG. 1 further depicts a user device 120, in data communication with the computer network 102 via a communications link 122. It will be appreciated by those skilled in the art that the user device 120 is shown in FIG. 1 as a personal computer for illustration purposes only. As will be understood by those skilled in the art, the user device 120 is representative of any personal computing device known in the art, including, for example and without limitation, a computer workstation, a laptop computer, a personal data assistant, a web-enabled cellular telephone, a smart phone, a proprietary network device, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 120 is suitably adapted to generate and transmit electronic documents, document processing instructions, user interface modifications, upgrades, updates, personalization data, or the like, to the document processing device 104, or any other similar device coupled to the computer network 102, or to receive electronic document data from the document processing device 104, server 114, or other similar devices coupled to the computer network 102.

Turning now to FIG. 2, illustrated is a representative architecture of a suitable device 200 (shown in FIG. 1 as the document processing device 104) on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device (shown in FIG. 1 as the document processing device 104) for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any is suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows is for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

In operation, electronic document data is first received from an associated scanning device. Document processing instruction data is then received associated with a plurality of document processing operations to be performed on the electronic document. The document processing instruction data is then appended to the electronic document as metadata. The electronic document data and appended metadata is then communicated to at least one document processing device for processing thereon. Upon receipt of the electronic document data, the at least one document processing device commences the plurality of document processing operations on the electronic document data in accordance with the appended metadata.

The skilled artisan will appreciate that suitable document processing operations include, for example and without limitation, optical character recognition, page orientation, page alignment, digital certification, storage, transmission, output, information extraction, and the like. It will be understood by those skilled in the art that such document processing operations are capable of being selected via the user interface 106 associated with the document processing device 104, via the user device 120, or the like.

In accordance with one example embodiment of the subject application, electronic document data is first received from a scanning device. It will be appreciated by those skilled in the art that a suitable scanning device is any electronic device capable of generating electronic image data representative of a hardcopy document. For purposes of this example, the scanning component of the document processing device 104 is capable of generating electronic document data, which is then received by the controller 108 or other suitable component associated with the document processing device 104. An associated user, who preferably initiated the scanning operation, is prompted to select, via the user interface 106, one or more document processing operations to be performed on the received electronic image data.

The selections made by the user are then converted by the controller 108 or other suitable component of the document processing device 104 into metadata representing the requested document processing operations. Thus, as will be appreciated by those skilled in the art, the metadata suitably comprises a workflow representative of a series of document processing operations, capable of being performed sequentially, in parallel, or the like. The metadata is then appended to the received electronic document data via any suitable means known in the art. Suitable document processing operations in accordance with one embodiment of the subject application include, for example and without limitation, optical character recognition, page orientation, page alignment, digital certification, storage, transmission, information extraction, and the like. It will be appreciated by those skilled in the art that information extraction, further includes, for example and without limitation, extraction of invoice number, sender information, destination information, content information, and the like. In accordance with one embodiment of the subject application, the user is able to select a single operation, which represents a workflow inclusive of multiple document processing operations.

The electronic document data, with appended metadata, is then communicated to a suitable document processor. As will be understood by those skilled in the art, the term document processor refers to any of a myriad of electronic devices, applications, hardware, software, or the like, capable of performing document processing operations on electronic document data. For example, FIG. 1 includes a user device 120 that is capable of functioning as a document processor in accordance with the subject application, i.e., the user device 120 includes software adapted for optical character recognition operations, data extraction, or the like. Similarly, the server 114 is capable of functioning as a document processor in accordance with the subject application, whereupon the server 114, for example, performs document management operations on the received electronic document data. The skilled artisan will also appreciate that the document processing device 104 is capable of functioning as a document processor in accordance with the subject application, such that the document processing device 104, or a suitable component thereof, performs one or more requested document processing operations. Thus, when the electronic document data is communicated to a document processor by the controller 108, it is in essence communicated from the controller 108 component of the document processing device 104 to the optical character recognition component, the facsimile component, a network interface component, or the like.

The document processor receiving the electronic document data then reads the metadata appended thereto to determine the requested document processing operations. A determination is then made by the processor whether the operations are capable of being performed contemporaneously, i.e., in parallel, or sequentially. When the operations are capable of contemporaneous performance, the requested document processing operations are performed in accordance with the metadata read from the received electronic document data. The processor then determines whether or not a processing error has occurred. When no errors are detected, a user notification is generated representing a completion notification signal indicating that the requested document processing operations have been performed. This completion notification signal is then communicated to the associated user, e.g., via the user interface 106, an electronic mail message, or the like. When an error is detected, an error notification signal is generated and communicated to the associated user, e.g., via the user interface 106, via electronic mail message to the user device 120, or the like.

When it is determined that the requested document processing operations, as dictated by the read metadata, are not capable of parallel performance, e.g., a subsequent operation requires data from a previous operation, the first document processor performs the first document processing operation, as set forth in the metadata. That first processor then determines whether an error has occurred during the performance of the requested document processing operation. When an error is detected by that processor, an error notification signal is generated by the processor and communicated to the user via the user interface 106. When no error is detected, the document processor then determines, based on the received metadata, whether any additional document processing operations remain to be performed. When no further operations remain in the workflow stipulated by the metadata, a notification is generated by the document processor indicating that the requested operations have been completed. Thereafter, a completion notification signal is communicated to the associated user, preferably via the user interface 106 or electronic mail message to the user at the user device 120.

In the event that an additional document processing operation remains to be performed, as set forth by the metadata, the document processor then determines whether or not another document processor is required to perform the next operation. That is, the document processor that has just completed performing a given operation will determine whether or not it is capable of performing the next document processing operation as directed by the metadata. When the current document processor is capable of performing the operation, the next operation is performed by the document processor and operations continue from there as set forth above. When the current document processor is not able to perform the next document processing operation, the output from the document processor, e.g., the partially processed electronic document data and corresponding metadata, is then communicated to the next document processor designated by the metadata.

The next document processor receives the electronic document data and metadata and performs the next document processing operation. The next processor then determines whether any errors have occurred during the performance of the document processing operation. In the event that an error is detected, the next document processor generates a notification signal to the user indicating the occurrence. When no error is detected by the next document processor, a determination is made whether the metadata dictates the performance of another document processing operation. When no further operations are required, a signal is communicated to the user indicating the completion of document processing operations. Such notification is accomplished via electronic mail messaging, visual indication on the user interface 106, or the like. When an additional document processing operation is required, as set forth by the metadata, the next document processor determines whether or not a different processor is required for performance of the operation. Thus, operations of the system 100 continue thereafter as described above until all requested document processing operations, as designated in the metadata, have been completed.

The foregoing example embodiment will be better understood in conjunction with the example series of requested document processing operations described hereafter. For purposes of this example, the series of requested operations includes a scan to optical character recognition operation, an indexing of the optical character recognition file operation, an addition of a digital signature operation, and a storage operation in a designated repository. The skilled artisan will appreciate that the subject application enables a workflow of lesser or greater complexity, using the same or different document processing operations. Thus, when the user selects a scan to optical character recognition operation, a workflow is appended to the electronic image data generated by the scanning component of the document processing device 104 as metadata. Preferably, the workflow embodied as metadata includes document processing instruction data representing the desired document processing operations to be performed, as well as other data relating to the performance of the document processing operations, e.g., file name conventions, destinations, recipients, file types, data to be extracted, and the like.

In this example, the scanning component associated with the document processing device 104 receives instructions, via the controller 108, to perform a scanning operation on a document, thereby generating electronic document data. It will be appreciated by those skilled in the art that the adjustment and rotation of an image created from the scanning operation is preferably handled by an optical character recognition component, as the component is capable of recognizing the correct orientation of an electronic image. The received electronic document data is then appended with metadata generated by the controller 108 corresponding to user selections received via the user interface 106. The controller 108 then determines that optical character recognition is required in accordance with the metadata, and the electronic document data is communicated to the optical character recognition component of the document processing device 104. It will be appreciated by those skilled in the art that while reference is made in this example to the document processing device 104 performing the optical character recognition operation, the subject application is capable of communicating the electronic document data, via the computer network 102, to the server 114, the user device 120, or the like, to perform the desired optical character recognition operation.

Once optical character recognition data has been generated, as set forth by the metadata, the controller 108 or other suitable component associated with the document processing device 104, determines the next component, or processor, to perform the next operation in the workflow set forth by the metadata. In the instant example, the next operation in the workflow is an extraction of data from the scanned document. Thus, from the optical character recognition content, information is extracted to populate, for example, a document management system. Information includes, for example and without limitation, invoice numbers, sender name, address, invoice amount, and the like. The next operation, in the workflow, is a digital signing of the document, which is determined based upon the metadata appended to the electronic document data. In accordance with such an operation, the management server 114 is also capable of functioning as a digital certificate server, as will be understood by those skilled in the art. That is, the management server 114 performs the document processing operation of digitally signing the electronic document in accordance with the metadata. Thereafter, the content information, retrieved via the optical character recognition operation, and the digitally signed electronic document data, are stored in a document management database on the storage device 116 associated with the management server 114. In the foregoing example, each document processing operation is analyzed to determine whether or not an error occurred during the performance of the operation by the document processing device 104, the server 114, or the like. When an error is detected, a notification is sent to the user, via the user interface 106, via electronic mail message notification to the user device 120, or the like. Furthermore, upon successful completion of the document processing operations stipulated by the appended metadata, a completion notification message is sent to the user via the user interface 106, electronic mail message to the user device 120, or the like.

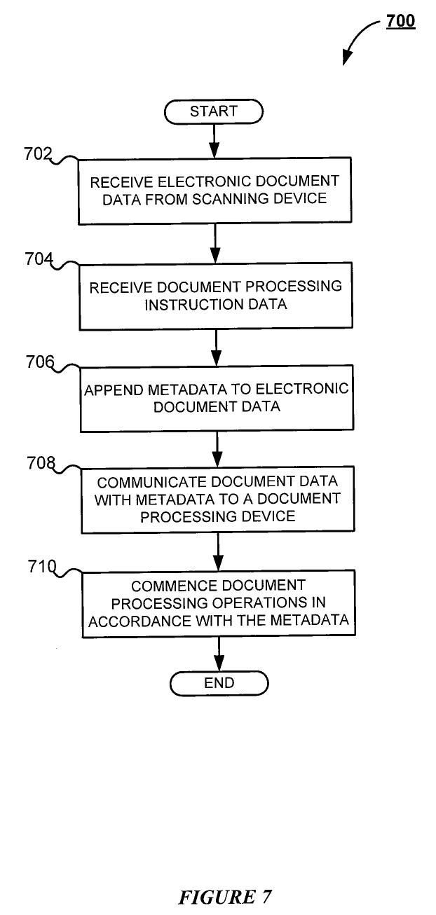

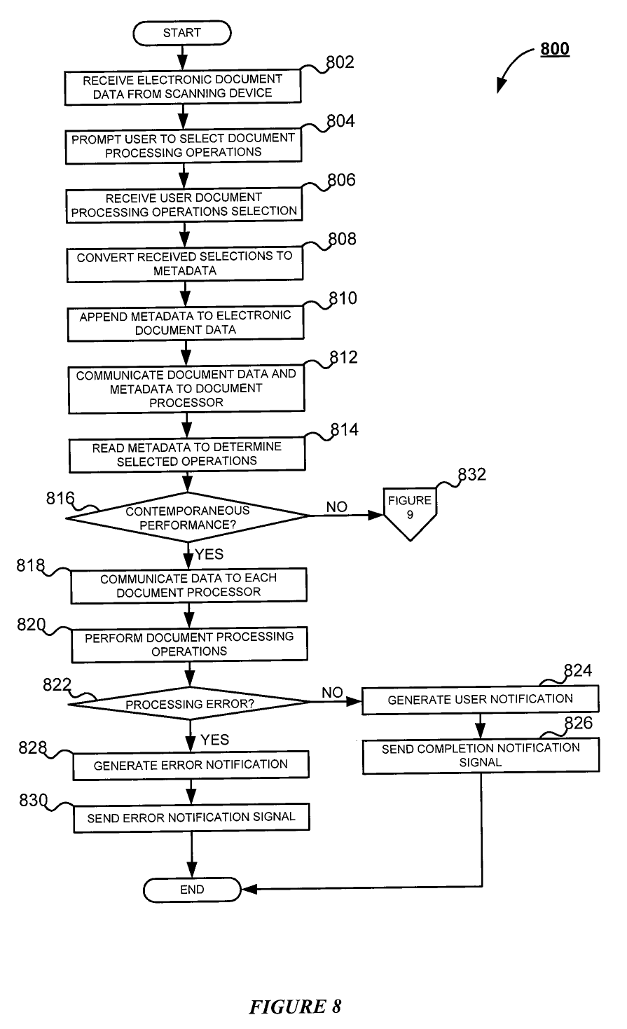

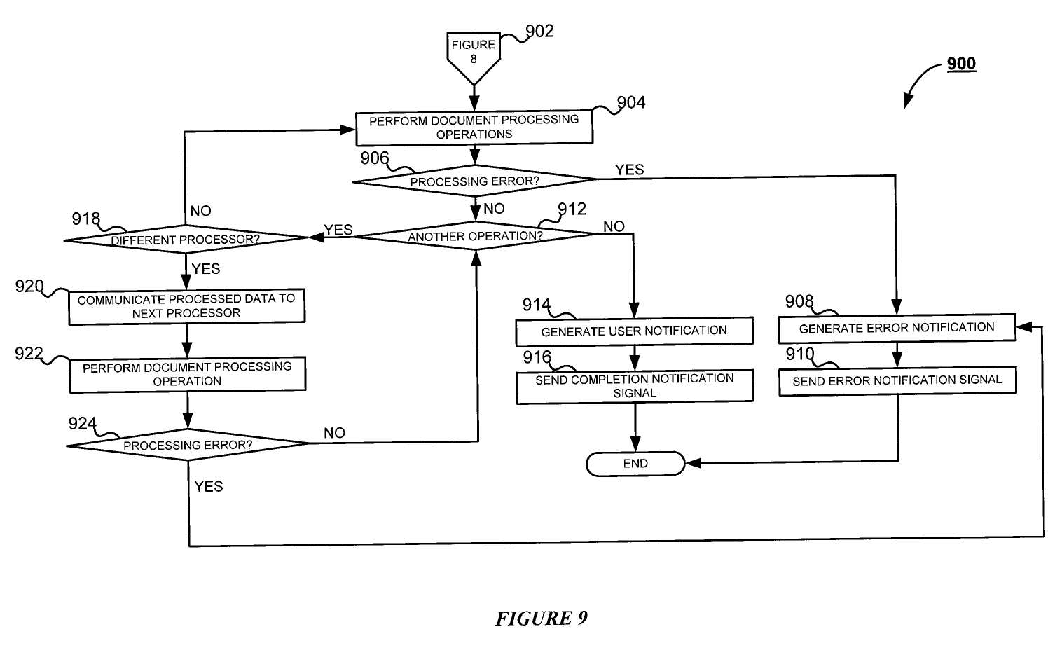

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7, FIG. 8 and FIG. 9. It will be appreciated by those skilled in the art that while reference is made hereinafter to the document processing device 104, or a suitable component thereof, performing the majority of the functions below, any computing device equipped with appropriate hardware, software, or a combination thereof, are capable of processing electronic documents and should be considered document processing devices similar to the document processing device 104.

Turning now to FIG. 7, there is shown a flowchart 700 illustrating a workflow control method for scanned document input in accordance with one embodiment of the subject application. Beginning at step 702, electronic document data is received from an associated scanning device. At step 704, document processing instruction data is received corresponding to a plurality of document processing operations to be performed on the received electronic document data. Metadata, corresponding to the document processing instruction data, is then appended to the electronic document data at step 706. At step 708, the document data with appended metadata is communicated to at least one associated document processing device so as to commence, at step 710, the plurality of document processing operations on the electronic document data in accordance with the appended metadata.

Referring now to FIGS. 8 and 9, there are shown flowcharts 800 and 900, respectively, illustrating a workflow control method for scanned document input in accordance with one embodiment of the subject application. The method depicted in the flowchart 800 of FIG. 8 begins at step 802, whereupon electronic document data is received from an associated scanning device. In accordance with one embodiment of the subject application, the associated scanning device is a component associated with the document processing device 104, e.g., a multifunction peripheral device, as will be understood by those skilled in the art. At step 804, an associated user is prompted, via the associated user interface 106, to select a set of document processing operations to be performed on the scanned document input, i.e., the electronic document data. It will be appreciated by those skilled in the art that the associated user is capable of selecting, for example and without limitation, an optical character recognition operation, a page orientation operation, a page alignment operation, a digital certificate operation, a storage operation, a transmission operation, an information extraction operation, and the like. The skilled artisan will further appreciate that the information extraction operation is capable of extracting, from the electronic document data, information including, for example and without limitation, an invoice number, sender information, destination information, content information, and the like.

The controller 108, or other suitable component associated with the document processing device 104 then receives at step 806, via the user interface 106, document processing instruction data corresponding to the set of document processing operations selected by the user. The controller 108 then converts, at step 808, the document processing instruction data to metadata, as will be understood by those skilled in the art. The metadata is then appended to the received electronic document data at step 810. The electronic document data with appended metadata is then communicated, at step 812, to a document processor, i.e., a component associated with the document processing device 104 (as illustrated above with respect to FIG. 2), a device capable of performing a requested document processing operation, e.g., the server 114, the user device 120, or the like. For purposes of explanation only, reference is made herein to the document processing device 104 performing the majority of selected document processing operations, however the skilled artisan will appreciate that other devices coupled to the computer network 102 are equally capable of being employed to perform requested document processing operations.

The metadata is then read by the recipient document processor at step 814 so as to determine the document processing operation requested. Based upon the metadata appended to the received electronic document data, a determination is made at step 816 whether the selected document processing operations are to be performed contemporaneously (in parallel) or sequentially (in a specific order). When sequential operation is mandated by the metadata, flow proceeds to step 832, which prompts the method described in the flowchart 900 of FIG. 9, as explained in greater detail below. When contemporaneous processing is available flow proceeds to step 818, whereupon the electronic document data and appended metadata is communicated to each document processor designated to perform at least one of the selected document processing operations. The skilled artisan will appreciate that when contemporaneous processing is available, each component associated with the document processing device 104 to perform one of the selected operations receives the metadata and document data for processing.

Each document processor then performs the selected document processing operation at step 820. It will be understood by those skilled in the art that each document processor associated with the document processing device 104, i.e., components, performs the requested document processing operation in accordance with the metadata. A determination is then made at step 822 whether a processing error has occurred. When no errors have been detected, flow proceeds to step 824, whereupon a user notification is generated. At step 826, a completion signal, representing a successful performance of each document processing operation, is communicated to the associated user. Suitable means of communication include, for example and without limitation, a notification displayed via the user interface 106, an electronic mail message, or the like. When an error has been detected during performance of the requested document processing operations, flow proceeds from step 822 to step 828, whereupon an error notification is generated. The error notification is then communicated, at step 830, to the user via the user interface 106, an electronic mail message, or the like.

As stated briefly above, when it is determined at step 816 that contemporaneous, i.e., parallel, processing of the requested document processing operations is not available, flow proceeds from step 832 of FIG. 8 to step 902 of FIG. 9. Turning now to FIG. 9, there is shown a flowchart 900 illustrating a workflow control method for scanned document input in accordance with one embodiment of the subject application. The method begins at step 902 and continues to step 904, whereupon the recipient document processor performs its assigned document processing operation, as determined by the metadata. A determination is then made by the document processor at step 906 whether any processing errors have occurred. When a processing error has been detected, flow proceeds to step 908, whereupon an error notification is generated representing the error detected by the document processor. At step 910, the error notification, or signal, is communicated to the associated user, preferably via a display on the user interface 106, via electronic mail message, or the like.

When no errors have occurred during the performance of the document processing operation at step 906, flow proceeds to step 912, whereupon a determination is made, based upon the metadata appended to the electronic document data, whether any additional document processing operations remain in the workflow. A negative determination at step 912 prompts the generation, at step 914, of a completion user notification. At step 916, a completion notification signal, comprising the user notification, is communicated to the user via the associated user interface 106, an electronic mail message, or the like. A positive determination at step 912, i.e., at least one additional document processing operation remains in the workflow, prompts a determination at step 918 whether a different processor is required to perform the next document processing operation in the workflow. When the current document processor is capable of performing the next operation in the workflow, flow returns to step 904 for the performance of the next operation.

When it is determined at step 918 that the current processor is unable to perform the next document processing operation in the sequential workflow, the processed data (output from the current document processor) and metadata (representing the sequential workflow) are communicated at step 920 to the next document processor. The next document processor performs the next document processing operation in accordance with the received metadata at step 922. Thereafter, a determination is made at step 924 whether any errors have occurred during the performance of the document processing operation. When no errors have occurred, flow returns to step 912 for a determination, based on the metadata, of whether or not any additional document processing operations remain in the workflow. When an error is detected, flow returns from step 924 to step 908, whereupon an error notification is generated representing the processing error that has occurred. An error notification signal is then communicated to the associated user at step 910. Suitable notification signals include, for example and without limitation, a visual indication on the associated user interface 106, an electronic mail message, or the like. Operations continue thereafter in accordance with the methodology as set forth in greater detail above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A workflow control system for scanned document input comprising:
means adapted for receiving electronic document data from an associated scanning device;
means adapted for receiving document processing instruction data associated with a plurality of document processing operations to be performed on received electronic document data;
means adapted for appending metadata corresponding to document processing instruction data to electronic document data; and
means adapted for communicating the electronic document data and appended meta data to at least one associated document processing device so as to commence the plurality of document processing operations on the electronic document data in accordance with the appended metadata.

2. The workflow control system of claim 1 wherein the plurality of document processing operations are chosen from a set comprising: optical character recognition, page orientation, page alignment, digital certification, storage, transmission, and information extraction.

3. The workflow control system of claim 2 wherein information extraction includes at least one of extraction of invoice number, sender information, destination information, and content information.

4. The workflow control system of 1 further comprising means adapted for receiving a notification signal representative of at least one of a completion and processing error associated with document processing operations specified by the metadata.

5. The workflow control system of claim 4 further comprising means adapted for generating a message to an associated user in accordance with a received notification signal.

6. The workflow control system of claim 5 wherein the message is comprised of an electronic mail message.

7. The workflow control system of claim 1 wherein the at least one associated document processing devices includes a multifunctional peripheral device.

8. A workflow control method for scanned document input comprising the steps of:
receiving electronic document data from an associated scanning device;
receiving document processing instruction data associated with a plurality of document processing operations to be performed on received electronic document data;
appending metadata corresponding to document processing instruction data to electronic document data; and
communicating the electronic document data and appended meta data to at least one associated document processing device so as to commence the plurality of document processing operations on the electronic document data in accordance with the appended metadata.

9. The workflow control method of claim 8 wherein the plurality of document is processing operations are chosen from a set comprising: optical character recognition, page orientation, page alignment, digital certification, storage, transmission, and information extraction.

10. The workflow control method of claim 9 wherein information extraction includes at least one of extraction of invoice number, sender information, destination information, and content information.

11. The workflow control method of claim 8 further comprising the step of receiving a notification signal representative of at least one of a completion and processing error associated with document processing operations specified by the metadata.

12. The workflow control method of claim 11 further comprising the step of generating a message to an associated user in accordance with a received notification signal.

13. The workflow control method of claim 12 wherein the message is comprised of an electronic mail message.

14. The workflow control method of claim 8 wherein the at least one associated document processing devices includes a multifunctional peripheral device.

15. A computer-implemented method for workflow control of scanned document input comprising the steps of:
receiving electronic document data from an associated scanning device;
receiving document processing instruction data associated with a plurality of document processing operations to be performed on received electronic document data;
appending metadata corresponding to document processing instruction data to electronic document data; and
communicating the electronic document data and appended meta data to at least one associated document processing device so as to commence the plurality of document processing operations on the electronic document data in accordance with the appended metadata.

16. The computer-implemented method for workflow control of claim 15 wherein the plurality of document processing operations are chosen from a set comprising: optical character recognition, page orientation, page alignment, digital certification, storage, transmission, and information extraction.

17. The computer-implemented method for workflow control of claim 16 wherein information extraction includes at least one of extraction of invoice number, sender information, destination information, and content information.

18. The computer-implemented method for workflow control of claim 15 further comprising the steps of receiving a notification signal representative of at least one of a completion and processing error associated with document processing operations specified by the metadata and generating a message to an associated user in accordance with a received notification signal.

19. The computer-implemented method for workflow control of claim 18 wherein the message is comprised of an electronic mail message.

20. The computer-implemented method for workflow control of claim 15 wherein the at least one associated document processing devices includes a multifunctional peripheral device.
